(19) United States
(12) Patent Application Publication
(10) Pub. No.: US 2025/0269214 A1
(43) Pub. Date: Aug. 28, 2025

(54) DUAL-FUNCTION SUPPRESSION SYSTEM FOR MOBILE VEHICLES

(71) Applicant: Tyco Fire Products LP, Cranston, RI (US)

(72) Inventors: Alden A. Spencer, Marinette, WI (US); Chad L. Ryczek, Marinette, WI (US)

(73) Assignee: Tyco Fire Products LP, Cranston, RI (US)

(21) Appl. No.: 18/858,150

(22) PCT Filed: May 10, 2023
(86) PCT No.: PCT/IB2023/054845

§ 371 Date: Oct. 18, 2024

Related U.S. Application Data
(60) Provisional application No. 63/341,154, filed on May 12, 2022.

(51) Int. Cl. A62C 35/02; A62C 3/07; A62C 35/13

(52) U.S. Cl. CPC A62C 35/023; A62C 3/07; A62C 35/13

(57) ABSTRACT

A fire suppression system for a vehicle includes a fire detection device, a tank, a nozzle, and an activator. The fire detection device is configured to detect a fire in a hazard area. The activator is configured to selectively release during a single-agent phase the fire suppressant contained in the tank such that after the first tank is substantially emptied at least a portion of the pressurized gas passes through the outlet of the nozzle and floods the hazard area.

### CROSS-REFERENCE TO RELATED PATENT APPLICATIONS

This application claims the benefit of and priority to U.S. Provisional Application No. 63/341,154, filed May 12, 2022, the entire disclosure of which is hereby incorporated by reference herein.

### BACKGROUND

This present disclosure relates generally to fire suppression systems. More specifically, the present disclosure relates to fire suppression systems for industrial mobile equipment. Fire suppression systems are commonly used to protect an area and objects within the area from fire. Fire suppression systems can be activated manually or automatically in response to an indication that a fire is present nearby (e.g., an increase in ambient temperature beyond a predetermined threshold value, etc.). Once activated, fire suppression systems spread a fire suppressant agent throughout the area. The fire suppressant agent then suppresses or prevents the growth of the fire.

### SUMMARY

At least one embodiment relates to a fire suppression system for a hazard area in a vehicle containing a first tank, a second tank, a nozzle, and an activator. The first tank is configured to contain a volume of fire suppressant. The second tank is selectively fluidly coupled to the first tank and configured to contain a volume of pressurized gas. The nozzle has an outlet fluidly coupled to the first tank and configured to release a spray of at least one of the fire suppressant or the pressurized gas therefrom in the hazard area. The activator is configured to selectively release the pressurized gas from the second tank such that at least a portion of the pressurized gas pressurizes the first tank, wherein at least a portion of the fire suppressant passes through the outlet of the nozzle in response to the pressurization of the first tank. After the first tank is substantially emptied at least a portion of the pressurized gas passes through the outlet of the nozzle and floods the hazard area.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a side view of a vehicle including a dual-function fire suppression system, according to an exemplary embodiment.

FIG. 2 is a schematic diagram of the dual-function fire suppression system, according to some embodiments.

FIG. 3 is a perspective view of a spray of a nozzle of the fire suppression system of FIG. 1, according to an exemplary embodiment.

FIG. 4 is a side view of the spray of FIG. 3.

FIG. 5 is a top view of the spray of FIG. 3.

FIG. 6 is a diagram of a coverage area for a cartridge of a fire suppression system for mobile equipment, according to an exemplary embodiment.

FIG. 7 is a flow chart of an exemplary method of using a dual-function fire suppression system, according to an exemplary embodiment.

### DETAILED DESCRIPTION

Before turning to the FIGURES, which illustrate the exemplary embodiments in detail, it should be understood that the present disclosure is not limited to the details or methodology set forth in the description or illustrated in the FIGURES. It should also be understood that the terminology used herein is for the purpose of description only and should not be regarded as limiting.

As used herein, the term “hazard” means any component or surface that has a potential to act as fuel, flammable material, or an ignition source and thereby ignite, produce, sustain, or otherwise cause a flame to be emitted therefrom. A hazard can be a component or surface that routinely becomes heated and has the potential to come into contact with a combustible material. By way of example, the hazard can be an engine component that is routinely heated (e.g., an engine block, a turbocharger, a supercharger, an exhaust component, a pump, a filter, etc.) and that may be positioned adjacent a hose, pipe, or other type of conduit that has the potential to leak a combustible fluid (e.g., fuel, hydraulic oil, engine oil, etc.). By way of another example, the hazard can be an engine component that is routinely heated and that may be positioned such that flammable material from outside of the vehicle (e.g., grass clippings, wood chips, coal dust, refuse, etc.) can accumulate atop or otherwise in contact with the engine component. The terms “dual agent fire suppression system” and “twin-agent fire suppression system” are used herein interchangeable to denote fire suppression systems which use a dry agent and a liquid agent to suppress a fire, and including fire suppression systems which use a foaming liquid agent to ultimately apply a foam to a hazard.

As used herein, the term “non-fluorinated” means the firefighting agent, fire suppressant, or fire suppressant agent is produced without the use of per- and polyfluoroalkyl substance (PFSA) chemistry, and no PFSAs were intentionally added to the suppressants/agents during production. Trace amounts of PFSAs may however be present from incidental exposure during the production, transportation, storage, and/or use of the suppressants/agents.

### Overview

Referring generally to the FIGURES, a dual-function fire suppression system is configured for use with mobile equipment. The mobile equipment can be any vehicle, airborne platform, mining vehicle, etc., such as large non-road type construction and mining vehicles. The dual-function fire suppression system is configured to serve or provide fire suppression for one or more hazard areas in the mobile equipment.

Mobile equipment may be associated with a number of onboard hazards that have the potential to produce fires. By way of example, mobile equipment can include components that reach elevated temperatures during normal use. If the heated surfaces of these components come into contact with flammable materials, such as fuel or hydraulic oil, the flammable materials can combust, causing fires within the vehicle. The heated surfaces may become superheated, and in some cases the superheated surfaces can reach an excess of 2000° F., well above the 850° F. required to ignite fuels like hydraulic oil and diesel oil. At such temperatures, water may not be able to sufficiently cool the hazards below the ignition temperature of the fuels. Additionally, the mobile equipment may also operate in environments as cold as −40° F., such that water may be frozen and unavailable to suppress the fire. Fire suppression systems using specifically designed fire suppression agents can be installed onboard vehicles and configured to suppress such onboard fires.

Many vehicle components that are heated during use are contained or extend within specific areas, compartments, or enclosures of the vehicle, such as an engine compartment, or within other vehicle spaces. Onboard fire suppression systems can include one or more fixed nozzles that suppress fires caused by hazards within the enclosures. The dual-function fire suppression system also includes a controller, a fire detection device, a storage tank, a pressurized gas tank, a valve, and fluid conduits connected to the nozzles. The pressurized gas cylinder can be a pressure vessel configured to store an inert gas (e.g., nitrogen) for use in expelling a liquid fire suppressant agent from a fluidly coupled storage tank. Additionally, the pressurized gas cylinder may be configured to store an additional amount of inert gas above and beyond the amount needed for expelling the liquid fire suppressant, wherein the additional amount of inert gas is used for flooding the hazard area.

The present disclosure relates to a dual-function fire suppression system for mobile equipment operating in extreme temperatures (e.g., −40° F. or less to 140° F. or more) that expels fire suppressant from a storage tank using a fluidly coupled pressurized gas cylinder, wherein the pressurized gas cylinder is oversized such that after expelling the fire suppressant from the storage tank, inert gas continues to flow through the same fluid conduits and nozzles as the fire suppressant to flood the hazard area with the inert gas and aid in suppressing the fire and reducing the risk of re-ignition of the fire.

Other fire suppression systems having a fire suppressant expelled from a storage tank by pressurized inert gas are designed such that the inert gas is exhausted at approximately the same time as the fire suppressant. By limiting the volume of the inert gas the inert gas is only used for generating a propulsive effect, and fails to otherwise materially contribute to the fire suppression effort. Similarly, other fire suppression systems configured to flood an area and displace the oxygen in the area with an inert gas are typically designed for use in environments where sensitive electronics and other high value assets are stored that could be damaged by exposure to dry and/or wet non-gaseous fire suppressant agents. Other inert gas fire suppression systems are therefore designed to flood the area with a clean inert gas agent designed to not damage the assets within the hazard area but to still absorb the heat of the fire and suppress the flames. Additional disclosure regarding inert gas fire suppression systems may be found in International Application No. PCT/IB2020/061532, the entire disclosure of which is incorporated by reference herein. However, by using the inert gas only to flood the space, other inert gas fire suppression systems waste the kinetic energy potential of the expanding inert gas as it is released from its pressurized cylinder. Without the need for a second dedicated inert gas system, the dual-function fire suppression system of the present disclosure uses the inert gas to both deliver a fire suppressant agent to a fire in a hazard area and to flood the hazard area, using the kinetic energy of the gas to dispense the fire suppressant while using an additional volume of gas through the same equipment to displace the oxygen within the area and reduce the re-ignition potential.

### Vehicle

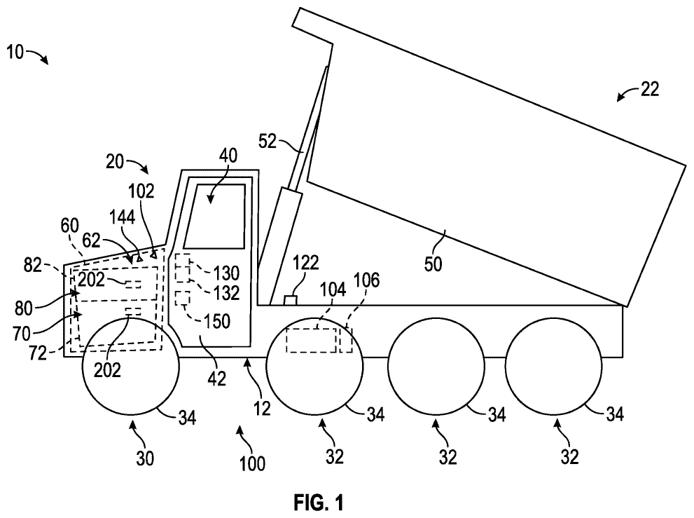

Referring to FIG. 1, mobile equipment is shown according to an exemplary embodiment. The mobile equipment is shown as a vehicle 10. The vehicle 10 may be any type of vehicle, such as a commercial vehicle, a farm vehicle, an industrial vehicle, or a consumer vehicle. Such vehicles can include, but are not limited to: draglines, slag pot carriers, slab carriers, tunnel boring machines, waste management equipment, forestry vehicles, hydraulic excavators, haul trucks, wheeled loaders, dozers, scoop trams, shuttle cars, public transportation vehicles, over-the-road trucks, cargo transport vehicles, graders, dump trucks, and consumer passenger vehicles. In some embodiments, the mobile equipment is designed to operate in temperatures below the freezing point of water.

In the embodiment shown in FIG. 1, the vehicle 10 is a dump truck. The vehicle 10 includes a chassis, shown as frame 12, extending longitudinally along the vehicle 10. The frame 12 supports a first portion of the vehicle 10, shown as body 20. In some embodiments, the frame 12 additionally supports a second portion of the vehicle 10, shown as equipment 22. In other embodiments, the equipment 22 is omitted. As shown in FIG. 1, the body 20 is positioned near the front of the frame 12 with respect to the direction of travel of the vehicle 10, and the equipment 22 is positioned rearward of the body 20. In other embodiments, the body 20 extends rearward of the equipment 22.

The vehicle 10 further includes a series of tractive assemblies, shown as front tractive assembly 30 and rear tractive assemblies 32. As shown, the vehicle 10 includes one front tractive assembly 30 and three rear tractive assemblies 32. In other embodiments, the vehicle 10 includes more or fewer front tractive assemblies 30 and/or rear tractive assemblies 32. The front tractive assembly 30 and the rear tractive assemblies 32 each include two or more tractive elements (e.g., wheels, tracks, etc.), shown as wheel and tire assemblies 34. The wheel and tire assemblies 34 are rotatably coupled to the frame 12 and engage the ground. The wheel and tire assemblies 34 support the frame 12, the body 20, and the equipment 22. The front tractive assembly 30 and the rear tractive assemblies 32 can include differentials, drive shafts, bearings, wheel hubs, brakes, and other components.

The body 20 includes a cabin, shown as front cabin 40. The front cabin 40 is configured to house one or more operators throughout operation of the vehicle 10. The front cabin 40 can include components that facilitate operation of the vehicle 10, such as seats, controls for driving the vehicle 10 (e.g., displays, gauges, a steering wheel, pedals, shift levers, etc.), and/or controls for operating the equipment 22 (e.g., touchscreens, switches, knobs, buttons, joysticks, etc.). The body 20 can include one or more doors 42 that open and close to selectively facilitate or prevent access to the front cabin 40. Alternatively, the vehicle 10 may be an autonomous or semiautonomous vehicle. Accordingly, certain processes, such as steering, braking, and accelerating the vehicle 10 and controlling the equipment 22 may be controlled by a controller onboard or offboard the vehicle. The controller may perform such operations without, or with reduced input from, an operator. In such embodiments, certain components may be removed from the front cabin 40 or the front cabin 40 may be omitted entirely.

The components included in the equipment 22 vary based upon the intended use of the vehicle 10. In the embodiment shown in FIG. 1, the vehicle 10 is a dump truck configured to haul and deposit material (e.g., ore, dirt, gravel, sand, coal, etc.). The equipment 22 includes a container, shown as bed 50, that is configured to contain a volume of material. The bed 50 can have an opening along a top side to facilitate depositing material into the bed 50 and an opening along a rear side to facilitate dumping material. The bed 50 is pivotally coupled to the frame 12. The equipment 22 further includes a linear actuator, shown as hydraulic cylinder 52, that is coupled to the frame 12 and the bed 50. The hydraulic cylinder 52 is configured to extend and retract to rotate the bed 50 relative to the frame 12 between a raised position and a lowered position. In the lowered position, the bed 50 is configured to store material for transport. In the raised position, shown in FIG. 1, the bed 50 is configured to dump the material out through the opening along the rear side of the bed 50. In some embodiments, the hydraulic cylinder is a part of a hydraulic system with at least 567.8 L (150 gal) of hydraulic fluid in the lines.

The body 20 further defines an enclosure, shown as engine compartment 60, defining a volume 62 that is at least partially enclosed by the engine compartment 60. As shown, the engine compartment 60 is positioned forward of the front cabin 40 and the equipment 22. In other embodiments, the engine compartment 60 is positioned rearward of the front cabin 40 and/or the equipment 22. Still in other embodiments, the engine compartment 60 is positioned below the front cabin 40. The engine compartment 60 can include one or more structural members (e.g., frame rails, support members, brackets, etc.), coverings (e.g., sheet metal that extends between structural members, firewalls, body panels, grills, etc.), movable members (e.g., doors, hoods, etc.), or other components coupled to the frame 12, all of which cooperate to define the volume 62. The volume 62 can be accessible, selectively accessible, or inaccessible by an operator positioned outside of the vehicle 10. By way of example, a door may be movable to selectively permit access to the volume 62. In other embodiments, enclosed or partially enclosed volumes are defined by an enclosure of the vehicle 10 other than the engine compartment 60. By way of example, such enclosures can include lubrication rooms, storage areas, and the front cabin 40.

According to an exemplary embodiment, the vehicle 10 includes a first drive system, shown as powertrain 70. The powertrain 70 may include a primary driver, shown as engine 72. The engine 72 receives fuel (e.g., diesel, gasoline, etc.) from a fuel tank and combusts the fuel to generate mechanical energy. In other embodiments, the primary driver is an electric motor that consumes electrical energy (e.g., stored in a battery, from a generator, etc.) to generate mechanical energy. The powertrain 70 further includes a transmission that receives the mechanical energy and provides a rotational mechanical energy output (e.g., at a different speed, torque, and/or direction of rotation than that of the engine 72). The transmission can be rotationally coupled to a transfer case assembly and one or more drive shafts. The one or more drive shafts can be coupled to one or more differentials configured to transfer the rotational mechanical energy from the one or more drive shafts to the front tractive assembly 30 and/or the rear tractive assemblies 32. The front tractive assembly 30 and/or the rear tractive assemblies 32 then propel the vehicle 10. According to an exemplary embodiment, the engine 72 is an internal combustion engine that utilizes compression-ignition of diesel fuel. In alternative embodiments, the engine 72 is another type of device (e.g., a fuel cell, an electric motor, a spark-ignition engine, etc.) that utilizes a different power source (e.g., compressed natural gas, gasoline, hydrogen, electricity, etc.). The powertrain 70 of the vehicle 10 can be a hybrid powertrain or a non-hybrid powertrain (e.g., a fully electric powertrain, a powertrain powered exclusively by an internal combustion engine, etc.). The powertrain 70 of the vehicle 10 can further include one or more turbochargers.

In some embodiments, the vehicle 10 includes a second drive system, shown as equipment drive system 80 (e.g., hydraulic system). The equipment drive system 80 is configured to power actuation of the equipment 22. The equipment drive system 80 includes a driver, shown as pump 82. The pump 82 is a hydraulic pump configured to supply pressurized hydraulic fluid to and/or remove pressurized hydraulic fluid from the hydraulic cylinder 52 to raise and lower the bed 50. The pump 82 can be directly powered by the engine 72, can be powered by another energy source (e.g., a second engine, an electric motor powered by energy stored in a battery, etc.). In other embodiments, the equipment drive system 80 is configured to provide a different type of energy to power actuation of the equipment 22 (e.g., pressurized gas, electrical energy, a rotating shaft, etc.). Accordingly, in such embodiments, the driver of the equipment drive system 80 may instead be a compressor, a generator, an electric motor, or another type of driver. Alternatively, the pump 82 can be omitted, and the equipment drive system 80 may be driven directly by the engine 72 (e.g., a through a drive shaft).

The powertrain 70 and/or the equipment drive system 80 extend at least partially within the volume 62 defined by the engine compartment 60. As shown in FIG. 1, the engine 72 and the pump 82 are positioned within the engine compartment 60. Other components of the powertrain 70 (e.g., the transmission, driveshafts, etc.) extend outside of the engine compartment 60. Other components of the equipment drive system 80 (e.g., hydraulic lines, valves, etc.) extend outside of the engine compartment 60. In other embodiments, the equipment drive system 80 is positioned completely within or completely outside of the engine compartment 60.

Throughout operation, one or more components or surfaces of the powertrain 70 and/or the equipment drive system 80 have the potential to supply flammable material or act as an ignition source, such that a flame is emitted therefrom. Such flames can occur as a result of malfunctioning components, buildup of outside sources of flammable material, or through other circumstances. By way of example, a fuel line or a hydraulic fluid line can rupture, spraying fuel or hydraulic fluid that acts as a flammable material to fuel a fire. By way of another example, flammable material from outside of the vehicle 10 (e.g., sawdust, grass clippings, coal dust, etc.) can build up and fuel a fire.

Throughout operation, many components of the powertrain 70 and the equipment drive system 80 regularly reach elevated temperatures. Components within the vehicle 10 can reach elevated temperatures due to the combustion of fuel (e.g., contact with the combusting fuel, contact with exhaust gasses, etc.), due to electrical resistance, due to resistance within a hydraulic or pneumatic circuit, due to friction, or through other sources. In some embodiments the components may even become superheated. As used herein, the term “superheated” means at or above 850° F. When flammable materials come into contact with such superheated components and surfaces, the flammable materials can ignite, causing flames to be emitted. In order to address superheated surfaces, a fire suppression agent is required capable of operating in the same operating temperature range of the mobile equipment and of reducing the temperature of superheated surfaces below 850° F.

Any component or surface that has a potential to act as fuel, flammable material, or an ignition source and thereby ignite, produce, sustain, or otherwise cause an undesired flame to be emitted therefrom is referred to herein as a “hazard.” Potential hazards within the vehicle 10 include, but are not limited to, heated surfaces of a block of the engine 72, motors, turbochargers, superchargers, filters, exhaust components, radiators, pumps, compressors, valves, wires, fluid lines, and filters.

### Dual-Function Fire Suppression System

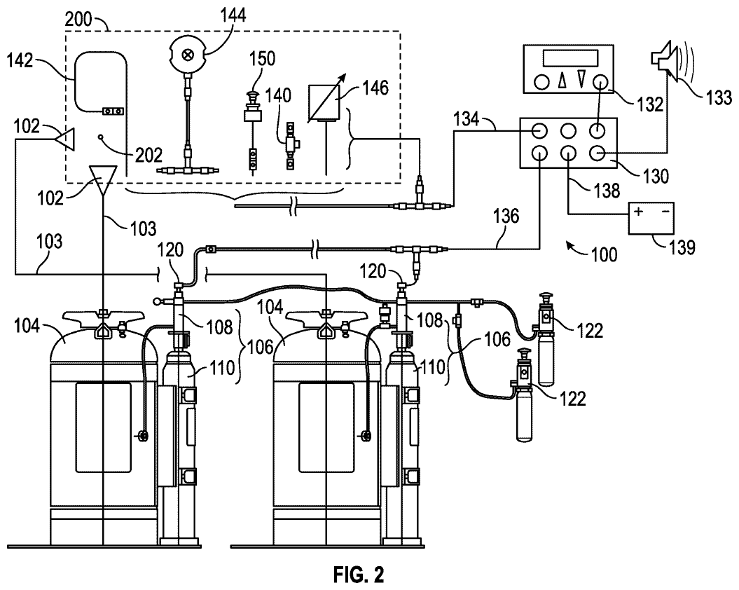

Referring to FIG. 2, the vehicle 10 further includes a combination dual-function fire suppression system 100. The dual-function fire suppression system 100 is configured to dispense or distribute a fire suppressant agent onto and/or nearby a fire in a protected hazard area, extinguishing the fire and cooling superheated surfaces in protected hazard area to prevent the fire from spreading or re-igniting. Additionally, after dispensing the fire suppressant, the dual-function fire suppression system 100 is configured to expel an additional volume of inert gas (e.g., nitrogen) into the hazard area to displace any oxygen in the space and further reduce the changes of re-ignition. The combination of the rapid cooling of the liquid fire suppressant agent and the inerting capability of the inert gas allows for a more efficient design and usage of agents for the compartment. Specifically, adding the inerting capability of the inert gas may allow the fire suppression system to operate with less fire suppression agent, reducing costs and providing a more environmentally friendly system.

The dual-function fire suppression system 100 supplies liquid fire suppressant agent to one or more nozzles 102 through fluid conduits (e.g., pipes, hoses, etc.), shown as hoses 103, to protect a hazard area 200. As shown in FIG. 2, the dual-function fire suppression system 100 includes one or more vessels, cylinders, or storage tanks 104 containing a fire suppressant agent. A pressurized cylinder assembly 106 (e.g., vessel, container, vat, drum, tank, canister, pressure vessel, can, cartridge, etc.) is configured to store pressurized expellant gas for pressurizing a corresponding one of the storage tanks 104 for delivery of the liquid agent under an operating pressure to the nozzles 102 to address a fire in the hazard area 200 and for flooding the hazard area 200 with an additional volume the expellant gas. In some embodiments, the liquid agent can be a foaming liquid agent which when mixed with air forms a foam to cover a hazard. The pressurized cylinder assembly 106 includes an inner volume configured to store an inert gas. The inert gas can be a nitrogen gas, or a mixture of nitrogen, argon, and carbon dioxide (CO2) gases. For example, the inert gas 26 can be an Inergen® gas mixture that includes 52% nitrogen, 40% argon, and 8% CO2 gases.

As shown, the pressurized cylinder assemblies 106 are positioned outside of the storage tanks 104. In other embodiments, pressurized expellant gas is stored within the storage tanks 104. In one embodiment, each pressurized cylinder assembly 106 includes an activator, shown as rupturing device 108, which punctures a rupture disc of a pressurized cylinder 110 containing a pressurized expellant gas, such as for example nitrogen, to pressurize the corresponding storage tank 104 for delivery of the fire suppressant agent under pressure.

In order to operate the rupturing device 108, the system 100 provides for automatic actuation and manual operation of the rupturing device 108 to provide for respective automated and manual delivery of the chemical agent in response to detection of a fire for protection of the hazard 202. In one embodiment, the rupturing device 108 includes a puncturing pin or member that is driven into the rupture disc of the pressurized cylinder 110 for release of the pressurized expellant gas. The puncturing pin of the rupturing device 108 may be driven electrically or pneumatically to puncture the rupture disc of the pressurized cylinder 110. In another embodiment, the activator is instead a valve or another type of device that selectively fluidly couples the storage tank 104 and the pressurized cylinder 110.

In one embodiment, the rupturing device 108 includes a protracted actuation device (PAD) 120 for driving the puncturing pin of the rupturing device 108 into the rupture disc. The PAD 120 generally includes an electrically coupled rod or member that is disposed above the puncturing pin. When an electrical signal is delivered to the PAD 120, the rod of the PAD is driven directly or indirectly into the puncturing pin which punctures the rupture disc of the pressurized cylinder 110. The system 100 can provide for automatic and/or manual operation of the PAD 120. The system 100 can further provide for one or more remote manual operating stations 122 to manually actuate the system 100. The manual operating stations 122 can rupture a canister of pressurized gas, for example, nitrogen at 1800 psi, to fill and pressurize an actuation line which in turn drives the puncturing pin of the rupturing device 108 into the rupturing disc thereby actuating the system 100.

In an alternative embodiment, the pressurized cylinder assembly 106 is omitted, and the fire suppressant agent is otherwise expelled from the storage tank 104. By way of example, the storage tank 104 may also be filled with a pressurized expellant gas, and the expellant gas may force the fire suppressant agent out of the storage tank 104 and through the hose 103, and after the fire suppressant agent is exhausted, the expellant gas can continue to flow to flood the hazard area. In such an embodiment, the system 100 may utilize a different type of activator instead of the rupturing device 108. By way of example, the system 100 may include a valve positioned downstream of the storage tank 104 (e.g., along one of the hoses 103, etc.) that selectively prevents flow of fire suppressant agent through the hoses 103 and out of the nozzles 102. In some embodiments, the fire suppressant agent is entirely contained in the storage tank 104 until released in response to a fire.

Referring again to FIG. 2, the system 100 includes a controller for automated and/or manual operation and monitoring of the system 100. In one embodiment, the system 100 includes a centralized controller or interface control module (ICM) 130. The system 100 can include a display device 132 coupled to the ICM 130 which displays information to a user and provides for user input to the ICM 130. In some embodiments, a user can provide a user input to the display device 132 to manually activate the liquid fire suppression system 100. An audio alarm or speaker 133 can also be coupled to the ICM 130 to provide for an audio alert regarding the status of the system 100.

ICM 130 is configured to monitor one or more conditions and determine if those conditions are indicative of a nearby fire. Specifically, ICM 130 is configured to receive the sensor signal(s) from one or more fire detection devices and determine if dual-function fire suppression system 100 should be activated based on the received sensor signal(s). In some embodiments, ICM 130 is configured to analyze the sensor signal(s) to identify if a fire condition or fire has occurred in the hazard area 14.

ICM 130 may include a processing circuit including a processor and memory. Processor may be a general purpose or specific purpose processor, an application specific integrated circuit (ASIC), one or more field programmable gate arrays (FPGAs), a group of processing components, or other suitable processing components. Processor is configured to execute computer code or instructions stored in memory or received from other computer readable media (e.g., CDROM, network storage, a remote server, etc.).

Memory may include one or more devices (e.g., memory units, memory devices, storage devices, etc.) for storing data and/or computer code for completing and/or facilitating the various processes described in the present disclosure. Memory may include random access memory (RAM), read-only memory (ROM), hard drive storage, temporary storage, non-volatile memory, flash memory, optical memory, or any other suitable memory for storing software objects and/or computer instructions. Memory may include database components, object code components, script components, or any other type of information structure for supporting the various activities and information structures described in the present disclosure. Memory may be communicably connected to processor via processing circuit and may include computer code for executing (e.g., by processor) one or more processes described herein. When processor executes instructions stored in memory, processor generally configures ICM 130 (and more particularly processing circuit) to complete such activities.

In some embodiments, ICM 130 includes a communications interface (e.g., a USB port, a wireless transceiver, etc.) configured to receive and transmit data. The communications interface may include wired or wireless communications interfaces (e.g., jacks, antennas, transmitters, receivers, transceivers, wire terminals, etc.) for conducting data communications external systems or devices. In various embodiments, the communications may be direct (e.g., local wired or wireless communications) or via a communications network (e.g., a WAN, the Internet, a cellular network, etc.). For example, the communications interface can include a USB port or an Ethernet card and port for sending and receiving data via an Ethernet-based communications link or network. In another example, the communications interface can include a Wi-Fi transceiver for communicating via a wireless communications network or cellular or mobile phone communications transceivers. In some embodiments, the communications interface facilitates wired or wireless communications between ICM 130 and one or more other components of the fire suppression system 100.

To provide for fire detection and actuation of the pressurized cylinder assemblies 106 and the liquid fire suppression system 100, the ICM 130 can further include an input data bus 134 coupled to one or more detection sensors, an output data bus 136 coupled to the PADs 120. Referring back to FIG. 2, ICM 130 may also include an input power supply bus 138 coupled to a power source, shown as battery 139, for powering the ICM 130 and the control and actuating signals

The input bus 134 provides for interconnection of digital and analog devices to the ICM 130. The input bus 134 can include one or more fire detection devices (e.g., sensors 310) and/or manual actuating devices 150. The fire detection devices of the system 100 can include analog and digital devices for various modes for fire detection including: (i) spot thermal detectors 140 to determine when the surrounding air exceeds a set temperature, (ii) linear detection wire 142 which conveys a detection signal from two wires that are brought into contact upon a separating insulation material melting in the presence of a fire, (iii) optical sensors 144 which differentiate between open flames and hydrocarbon signatures, and (iv) a linear pressure detector 146 in which pressure of an air line increases in the presence of sufficient heat. A manual actuating device 150 is shown as a manual push button which sends an actuating signal to the ICM 130 for output of an electrical actuating signal along to the PAD 120 of one or more of the pressurized cylinder assemblies 106. Accordingly, the system 100 provides for manual actuation of the system 100 by transmission of an electrical signal to the PAD 120. Together the fire detection devices and manual actuating devices 150 define a detecting circuit of the system 100 for automatic and/or manual detection of a fire event.

In some embodiments, the liquid fire suppression system 100 includes mechanical fire detection devices. By way of example, the liquid fire suppression system 100 can include a fusible link coupled to a cable or other type of tensile member that is held in tension. When the fusible link is exposed to a fire, solder within the fusible link melts, releasing tension on the cable. This change in tension can act as an input to the ICM 130 (e.g., through a strain gage or load cell). Alternatively, the cable can be coupled to the activator 312, and the activator 312 can be configured to pierce the rupture disc in response to a release of the tension on the cable. ICM 130 can obtain the sensor signal(s) from the sensors and analyze the sensor signal(s) to identify if one or more fire conditions have occurred at the hazard 202 and/or in the hazard area 200. For example, if the fire detection devices include a temperature sensor, ICM 130 can compare a detected temperature to a corresponding temperature threshold value. If the detected temperature exceeds the corresponding temperature threshold value, ICM 130 may determine that a fire condition has occurred at hazard area 200 (e.g., that a fire may be present) and may generate activation signal(s) for rupturing device 108 in response to determining that the fire condition has occurred at hazard area 200.

ICM 130 can be configured to analyze the sensor signal(s) to detect a variety of other fire conditions, including, but not limited to, rise rates (e.g., a rate of change of a detected temperature) that may indicate a fire condition (e.g., if the rise rate exceeds a threshold amount), optical sensor feedback indicating that a flame is present at hazard area 200, smoke detection, electrolyte gas detection, signals from mechanical fire detection devices, etc., or any other signal and/or property that can indicate a presence of fire or that a fire is likely to occur at hazard area 200.

Referring still to FIG. 2, upon detecting a nearby fire, ICM 130 activates the dual-function fire suppression system 100, causing the fire suppressant agent to leave nozzles 102 and extinguish the fire. After the fire suppressant agent is exhausted, the pressurized expellant gas continues to flow, flooding the hazard area and displacing oxygen therefrom. The liquid fire suppression agent is exhausted when the one or more storage tanks are substantially empty and almost no liquid fire suppressant is flowing through the nozzles.

In some embodiments, rupturing device 108 operates to selectively fluidly couple pressurized cylinder 110 with one or more storage tanks (e.g., storage tanks 104) configured to contain a fire suppressant agent and one or more nozzles (e.g., nozzles 102) in hazard area 200 so that hazard area 200 is sprayed with the fire suppressant agent and subsequently flooded with inert gas. The inert gas may be pressurized when stored within pressurized cylinder 110 so that when exposed to the low pressure environment (e.g., storage tanks 104, hazard 200) surrounding it via an activator such as rupturing device 108, the force of the expanding inert gas is sufficient to both deliver the liquid fire suppressant to the hazard area 200 and/or hazard 202 as well as flood the hazard area 200 with the expellant gas.

The ICM 130 can receive input signals on the input bus 134 from the fire detection devices for processing and where appropriate, generating an actuating signal to each PAD 120 along the output bus 136. In operation, upon detection of a fire event (e.g., automatically or manually), the ICM 130 activates each PAD 120, causing the activator (e.g., rupturing device 108) to fluidly couple the pressurized cylinder 110 and the storage tank 104. In embodiments where the pressurized cylinder assembly 106 is omitted, the ICM 130 may instead interact with (e.g., activate) a different type of activator. Alternatively, the rupturing devices 108 can be activated mechanically using the manual operating stations 122. The expellant gas forces the fire suppressant agent out through the hoses 103 and the nozzles 102, suppressing any fires near the hazards 202. The fire suppressant agent is expelled until the storage tank 104 is depleted (e.g., exhausted), at which point the expellant gas continues to flow and flood the hazard area with an additional volume of expellant gas.

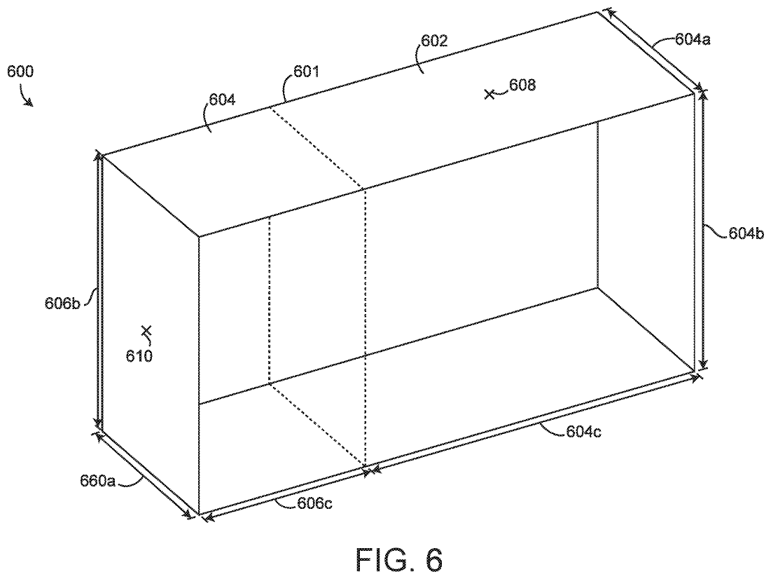

Referring to FIGS. 2 and 6, the size of the pressurized cylinders 110 may be application-specific, and can be tailored based on design parameters to provide adequate fire suppression for a particular or specific space (e.g., a specific hazard area such as volume 62 of vehicle 10). For example, the size and/or number of one or more storage tanks 104 and/or the pressurized cylinders 110 can be determined to provide space-specific dual-function fire suppression for a specific space (e.g., based on design parameters of the specific space). In some embodiments, the number of nozzles 102 present in the system 100 and the volume of the protected hazard area are considered such that a desired volume of fire suppressant agent expelled through each nozzle 102 and a desired volume of pressurized expellant gas is included for flooding the hazard area after the fire suppressant agent is exhausted. For example, the volume of pressurized expellant gas may depend on the number of nozzles 102, the volume of liquid fire suppressant to be delivered, and the volume of the hazard area. In some embodiments, the pressurized cylinder 110 has a capacity of 3, 5, 10, 15, 30, 45, 50, or 75 gallons. These capacities can correspond with the use of between 6 and 30 nozzles 102. The average time required to completely discharge the storage tank 104 and the pressurized cylinder 110 can range from between 20 and 120 seconds.

In some embodiments, a volume of the space (e.g., volume 62 of vehicle 10) for which fire suppression is desired is estimated. The total volume of pressurized gas can include a first volume sufficient to deliver the liquid fire suppressant, and a second volume sufficient to flood the volume of the space (e.g., reduce the oxygen level in the space to below a critical level necessary for combustion). In some embodiments, the volume of the space is used (e.g., by a design controller, processing circuitry, a circuit, an engineer, etc.) to determine the amount (e.g., volume) of pressurized expellant gas (i.e., inert gas) to be provided in addition to the first volume so that a certain percentage of atmosphere in the space is replaced with the inert gas when the second amount of inert gas is provided into the space. In some embodiments, the volume of the space is referred to as a hazard volume. In some embodiments, the hazard volume of the space is used to determine the amount or quantity of inert gas that is configured to flood the space after the delivery of the liquid fire suppressant. In some embodiments, the amount or quantity of inert gas is determined based on the hazard volume, a lowest anticipated hazard temperature (e.g., a lowest anticipated temperature in the hazard area 200 during normal operating conditions), an altitude of the hazard volume above or below sea level, a critical level of oxygen, and/or any other geometry of the hazard volume. In some embodiments, any of the design parameters described herein (e.g., the hazard volume, the lowest anticipated hazard temperature, the altitude of the hazard volume above or below sea level, geometry of the hazard volume, types of equipment in the hazard volume, etc.) are assumed for worst case scenario when determining the amount of pressurized expellant gas that should be provided for fire suppression.

Referring now to FIG. 6 a diagram 600 illustrating different coverage areas or volumes for pressurized cylinders 110 to fill with an inert gas are shown, according to some embodiments. Diagram 600 illustrates a volume 601 or a space for which fire suppression (e.g., by providing an liquid fire suppressant and a flood of expellant gas to the volume 601) is desired. In some embodiments, the volume 601 is a space that has a volume V_{space} (e.g., volume 62). In some embodiments, if the volume V_{space} exceeds an amount that can be provided by a single cartridge, the volume V_{space} is divided into sub-sections, each of which correspond to a different cartridge and nozzle. As shown in FIG. 6, the volume 601 is divided into a first sub-volume 602 and a second sub-volume 604, according to some embodiments. In some embodiments, the first sub-volume 602 and the second sub-volume 604 are each serviced by a corresponding nozzle and set of storage tanks and pressurized expellant gas containers. For example, the first sub-volume 602 may have a nozzle positioned at location 608 to provide a liquid fire suppressant and expellant gas to the first sub-volume 602, and the second sub-volume 604 may have a nozzle positioned at location 610 to provide a liquid fire suppressant and expellant gas to the second sub-volume 604. In some embodiments, the nozzles positioned at the locations 608 and 610 each have a corresponding tank or container of liquid fire suppressant and expellant gas.

As shown in FIG. 6, the first sub-volume 602 has a depth 604a, a height 604b, and a length 604c. Similarly, the second sub-volume 604 has a depth 606a, a height 606b, and a length 606c. The depth 604a, the height 604b, and the length 604c define a volume V₁ of the first sub-volume 602. The depth 606a, the height 606b, and the length 606c define a volume V₂ of the second sub-volume 604. In some embodiments, a size of the pressurized cylinder that fluidly couples with the storage tanks and the nozzle for the first sub-volume 602 is designed based on the volume V₁ of the first sub-volume 602. For example, the volume V₁ may be used to determine both the amount of liquid fire suppressant required to suppress a fire in the volume V₁ (and relatedly the amount of pressurized gas required to deliver the liquid fire suppressant), as well as the additional amount of pressurized gas required to flood the volume V₁ and reduce the oxygen level in the volume V₁ below the critical level. In some embodiments, a size of the pressurized cylinder that fluidly couples with the storage tanks and the nozzle for the second sub-volume 604 is designed based on the volume V₂ of the second sub-volume 604. For example, the size or capacity of the container that fluidly couples with storage tank and the nozzle for the first sub-volume 602 can be sufficient to include a first volume of the expellant gas used to deliver the liquid fire suppressant to the first sub-volume 602, and a second volume of expellant used to flood the volume V₁, such that when the expellant gas is discharged into the second sub-volume 604, a certain percentage of the volume V₁ is the expellant gas and the oxygen is below a certain level. Similarly, the size or capacity of the container that fluidly couples with the nozzle for the second sub-volume 604, a certain percentage of the volume V₂ is the expellant gas and the oxygen is below a certain level.

Once the total amount of pressurized expellant gas is determined (e.g., based on the volume of the hazard area, the amount of liquid fire suppressant to be delivered) for providing adequate expellant pressure for the fire suppressant agent and for fire suppression in the hazard volume, a number and/or size of pressurized expellant gas fire suppression containers (i.e., pressurized cylinders 110) is determined to contain and discharge the amount of pressurized expellant gas. As described above, in some embodiments, if the amount of pressurized expellant gas required cannot be contained in a single container, multiple containers are used to provide the pressurized expellant gas to the hazard volume. In this way, the size and number of the pressurized expellant gas containers can be tailored or configured for specific use with a specific hazard volume. The configuration of the pressurized expellant gas containers 18 may be provided according to any of the embodiments described herein with reference to FIGS. 1 and 2 (e.g., a single pressurized cylinder assembly 106 connected in series with a single storage tank 104, multiple sets of pressurized cylinder assemblies 106 connected in series with storage tanks 104, etc.). In some embodiments, multiple pressurized cylinder assemblies 106 are connected to each of the one or more storage tanks 104.

Referring again to FIG. 2, in some embodiments, the ICM 130 is configured to extinguish the fire with only the fire suppressant agent and the expellant gas. Upon detection of a fire (e.g., automatically or manually), the ICM 130 activates each PAD 120, causing the rupturing device 108 to fluidly couple the pressurized cylinder 110 and the storage tank 104 and causing the fire suppressant to address the fire, following by flooding the hazard volume using the remaining expellant gas from the pressurized cylinder 110. In some embodiments, the fire suppressant agent is used without the addition of another non-gaseous fire suppressant agent in a “single-agent” phase. Specifically, when the fire suppressant agent is expelled during a single-agent phase, at the beginning of the single-agent phase the fire is an untreated fire. As used herein, the term “untreated fire” means a fire that has yet to be addressed by a fire suppression system and/or has not come into contact with a fire suppressant agent. During the single-agent phase, the dual-function fire suppression system 100 causes the fire suppressant agent to be expelled into the protected hazard area in addition to the inert gas used to propel the fire suppressant agent. Therefore, in some embodiments, during the single-agent phase the untreated fire only comes into contact with the fire suppressant agent and the inert gas. The inert gas both propels the fire suppressant agent out of the nozzles 102, and after the storage tanks 104 are exhausted, continues to flow through the nozzles 102 and flood the space to displace a portion of the atmosphere in the hazard area. The critical temperature is the temperature at which one or more flammable materials in the protected hazard area may ignite and/or re-ignite at. For example, the critical temperature may be 850° F. (454° C.).

In some embodiments, the fire suppressant agent is a liquid fire suppressant agent. The liquid fire suppressant agent knocks down the flames of the fire and cools any superheated surfaces in the protected hazard area to below a critical temperature. In some embodiments, the fire suppressant agent is a dry fire suppressant agent. The dry fire suppressant knocks down the flames of the fire. An exemplary dry agent that may be used in conjunction with the fire suppressant system disclosed herein may be the FORAY multipurpose dry chemical agent manufactured by ANSUL®, a brand of Tyco Fire Protection Products. It should be understood that while the disclosure below may reference a liquid fire suppressant agent or a dry fire suppressant agent in isolation, it is contemplated that a one may be substituted for the other unless specified to the contrary.

In some embodiments, the dual-function fire suppression system 100 can be designed to cause a sufficient volume of inert gas to be expelled through the nozzles 102 for a sufficient length of time after the exhaustion of the liquid fire suppressant (i.e., when liquid fire suppressant is no longer being sprayed through the nozzles 102) such that after a complete discharge of the storage tank 104 and the pressurized cylinder 110 the superheated surfaces in the protected hazard area are below the critical temperature and the hazard area is flooded with the inert gas. Liquid fire suppressant is especially adept at reducing the temperature of superheated surfaces. In some embodiments, the selection of a liquid fire suppressant or a dry fire suppressant is dependent on the hazards and the specific use case. For example, in a large vehicle with superheated surfaces such as turbochargers predicted to be 1200° F. or hotter, the dual-function fire suppression system 100 can be designed to cause enough liquid suppressant agent to be expelled to bring the temperature of the superheated surfaces from 1200° F. to 850° F. and enough inert gas to be expelled to flood the engine compartment.

In some embodiments, at the end and/or directly after the single-agent phase, the fire is suppressed and the superheated surface(s) in the protected hazard area are below the critical temperature. No other fire non-gaseous suppressant agent is needed to suppress the fire.

Referring back to FIG. 1, the dual-function fire suppression system 100 is included onboard the vehicle 10. Accordingly, the dual-function fire suppression system 100 stays with the vehicle 10 to protect the vehicle 10 during periods of operation and/or periods of inactivity (e.g., storage, transport, etc.). As shown, the nozzle 102 is positioned within a protected hazard area, shown as engine compartment 60, to protect hazards included in the powertrain 70 and the equipment drive system 80. An optical sensor 144 is positioned within the engine compartment 60 to detect fires within the engine compartment 60. Other detection devices (e.g., the spot thermal detectors 140, the linear detection wires 142, the linear pressure detector 146, etc.) can additionally or alternatively be used. Nozzles 102 and sensors can additionally be included in other areas of the vehicle 10 to protect hazards located elsewhere within the vehicle 10. The storage tanks 104 and the pressurized cylinder assembly 106 are coupled to the frame 12 and positioned outside of the engine compartment 60. The ICM 130 and the display device 132 are positioned within the front cabin 40 to facilitate access by an operator of the vehicle 10. A manual actuating device 150 is positioned within the front cabin 40, and a manual operating station 122 is coupled to the frame 12 outside the front cabin 40 to facilitate manual activation of the dual-function fire suppression system 100 from anywhere on the vehicle 10. It should be understood that the locations of these components shown in FIG. 1 are exemplary only, and the dual-function fire suppression system 100 can be otherwise positioned within the vehicle 10 in other embodiments. In some embodiments, the hazard area 200 is an enclosed space. In other embodiments, the hazard area 200 is partially enclosed space.

Additionally or alternatively, the vehicle 10 can include nozzles 102 positioned to protect hazards 202 positioned outside of the engine compartment 60. Such nozzles 102 and hazards 202 can be positioned within enclosures of the vehicle 10 other than the engine compartment 60 (e.g., lubrication rooms, enclosures that contain components of the equipment drive system 80 but do not contain the engine 72, etc.). Alternatively, in some embodiments, one or more the nozzles 102 and hazards 202 can be positioned outside of enclosures and exposed to the surrounding environment. Examples of hazards 202 that can be positioned outside of the engine compartment 60 and/or other enclosures include brakes, hydraulic pumps, filters, batteries, tires, mobile generators, and conveyors.

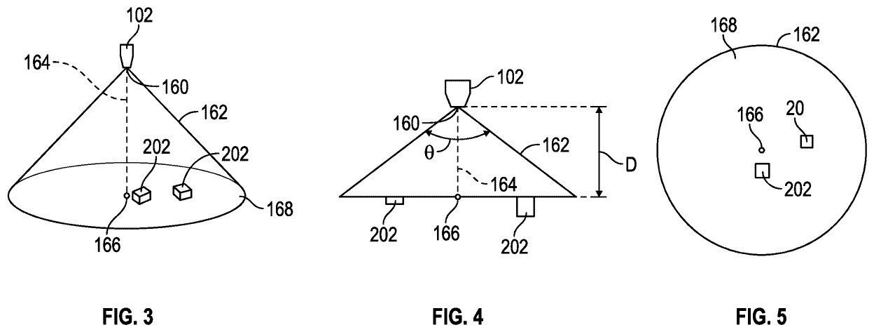

Referring now to FIGS. 3-5, each nozzle 102 has an outlet 160, from which inert gas and a spray 162 of fire suppressant agent is released during activation of the dual-function fire suppression system 100. The outlet 160 is fluidly coupled to the hoses 103 such that fire suppressant agent can be supplied to the outlet 160 from the storage tanks 104 and the inert gas from the pressurized cylinders 110 (via the storage tanks). In some embodiments, the pressurized cylinders 110 are directly connected to the nozzles 102, without needing to go through the storage tanks 104. The spray 162 extends along an axis 164 toward a point 166. The axis 164 is oriented generally toward one or more hazards 202, such that the spray 162 suppresses any fires and prevents subsequent ignitions caused by the hazards 202. The spray 162 directly blankets or covers an area, shown as blanketed area 168, with fire suppressant agent. The blanketed area 168 is defined perpendicular to the axis 164. In one embodiment, the blanketed area 168 is circular. The spray 162 further has a coverage area or effective suppression area at the hazard 202. The spray 162 is effective at suppressing fires located within the effective suppression area. Accordingly, if a hazard 202 is located within the effective suppression area, the hazard 202 is protected by the spray 162. The effective suppression area may be limited to the enclosed space around the hazard 202. The effective suppression area may be larger than and extend outside of the blanketed area 168. As such, a hazard 202 located outside of the blanketed area 168 can still be protected by the spray 162. The effective suppression area may be circular, similar to the blanketed area 168. Alternatively, the effective suppression may have another shape (e.g., organically shaped, square, triangular, etc.).

The blanketed area 168 of the spray 162 increases in size as the spray 162 extends along the axis 164 away from the outlet 160. The nozzle 102 is placed such that the outlet 160 is a distance D away from the nearest hazard 202. The distance D is measured along the axis 164. The nozzle 102 can be placed such that distance D is greater than 48 inches. In some embodiments, the distance D is greater than 54 inches. In some embodiments, the distance D is at least 60 inches. The size of the effective suppression area may be selected based upon the type of area that is desired to be covered. Having the ability to select different effective suppression areas may facilitate covering different sized hazards with minimal overspray beyond the desired coverage area.

In some embodiments the dual-function fire suppression system 100 described above is a twin-agent system. The dual-function fire suppression system 100 when used as a twin-agent system may include additional pressurized cylinders 110, storage tanks 104, fluid conduits 103, and nozzles 102 for use with a dry agent in addition to the pressurized cylinder 110, storage tanks 104, fluid conduits 103, and nozzles 102 for use with a liquid fire suppressant agent. The twin-agent system may include a twin-agent phase similar to the single-agent phase as described above, except that the fire suppressant agent is not used to the exclusion of another non-gaseous fire suppression agent, but with and/or in addition to another non-gaseous fire suppression agent such as a dry/wet agent depending on the initial fire suppressant agent used. In the twin-agent phase, the dry agent and the liquid fire suppressant agent may be simultaneously applied to the fire by dual-function fire suppression system 100, after which the inert gas may continue to flow until the pressurized cylinder 110 is exhausted. Specifically, the pressurized cylinders 110 are configured to contain a volume of pressurized inert gas sufficient to pressurize and empty the storage tanks 104 of both dry and wet agents as well as flood the hazard area (e.g., the effective suppression area). In other embodiments of a twin-agent fire suppression system using the liquid fire suppressant agent with a dry agent, the twin-agents and additional volume of inert gas may be released in series, with the dry agent being released prior to the release of the liquid fire suppression agent, after which the additional volume of inert gas sized to flood the hazard area is released. In some embodiments, the liquid fire suppressant agent is not released until one of the storage tanks 104 containing the dry agent is exhausted. In other embodiments, the liquid fire suppressant agent is released, for example by ICM 130, after the dry agent is released but prior to the exhaustion of the tank 104.

### Process

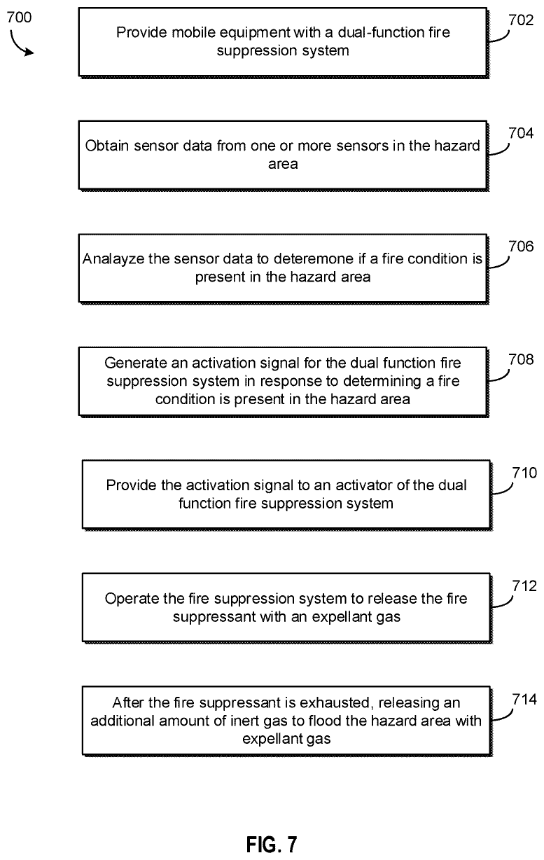

Referring now to FIG. 7, a process 700 for suppressing a fire in a hazard area of mobile equipment is shown, according to an exemplary embodiment. Process 700 can be performed to suppress, extinguish, prevent, or otherwise control a fire or a fire condition. Mobile equipment can be any vehicle (e.g., an off-road vehicle), airborne platform, transportable device, equipment, crane, port, etc., that may experience vibrations due to performing its respective operations (e.g., transportation operations, mining operations, etc.). Process 700 can include steps 702-714 and may be performed using dual-function fire suppression system 100.

Process 700 includes providing mobile equipment with a dual-function fire suppression system (step 702). The dual-function fire suppression system may be dual-function fire suppression system 100. The fire suppression system is designed such that the fire suppressant is stored in one or more tanks, and a pressurized expellant gas is provided to pressurize the storage tanks and expel the fire suppressant. Additionally, the pressurized expellant gas is stored in a pressurized cylinder (e.g., pressurized cylinder 110) that is oversized. That is, the pressurized cylinder is sized such that it contains a volume of pressurized expellant gas (e.g., inert gas) sufficient to both substantially empty the storage tanks of fire suppressant and to flood the hazard area with expellant gas. The volume of expellant gas provided may be determined based on the number of nozzles in the fire suppression system and the volume of the hazard area (i.e., the hazard volume). The fire suppression system may be designed such that the expellant gas floods the hazard area using the same fluid conduits and nozzles that delivered the liquid fire suppression agent.

Process 700 includes obtaining sensor data from one or more sensors in a hazard area of mobile equipment (step 704), according to some embodiments. Step 704 can be performed by a controller (e.g., ICM 130), a processing device, processing circuitry, etc., of an inert gas fire suppression system. Step 704 can include obtaining temperature readings, smoke detection data, optical sensor data, etc., or data from any other sensors that can be used to detect a fire condition at the hazard area. The sensor data may be wired or connected wirelessly. For example, the ICM 130 may be electrically coupled with the sensors via one or more wires, or may be configured to communicate with the sensors via a wireless communications protocol (e.g., Bluetooth, LoRa, Zigbee, etc.).

Process 700 includes analyzing the sensor data obtained from the one or more sensors to determine if a fire condition is present at the hazard area (step 706), according to some embodiments. In some embodiments, step 706 is performed by ICM 130. ICM 130 may perform step 706 by analyzing the sensor data according to a fire detection algorithm. ICM 130 may compare the sensor data to a corresponding value (e.g., a threshold value), ranges, etc., to identify if the sensor data is within an expected range, below an expected value, etc. If the sensor data is not within the expected range or is above the expected value (e.g., a threshold value), the controller may determine that a fire condition is present at the hazard area. In some embodiments, for example those which use mechanical fire detection devices, step 706 includes receiving the signal from the mechanical detection device indicating fire and immediately concluding a fire is present in the hazard area. Process 700 proceeds to step 706 in response to detecting that a fire condition is present at the hazard area.

Process 700 includes generating an activation signal for a fire suppression system in response to determining that a fire condition is present at the hazard area (step 708), according to some embodiments. In some embodiments, step 708 is performed by ICM 130. ICM 130 can generate a signal for a activator (e.g., rupturing device 108) so that the rupturing device operates to open to allow the inert gas to pressurize the storage tank(s) of fire suppressant. It should be understood that step 706 can include generating activation signals for a valve, a another rupture device, or any other activating device.

Process 700 includes providing the activation signals to an activator of the dual-function fire suppression system (step 710), according to some embodiments. In some embodiments, the activation signals are provided by ICM 130 to rupturing device 108 so that the rupturing device 108 operates to activate the fire suppression system 100.

Process 700 includes operating the fire suppression system to release the fire suppressant using the expellant gas (step 712), according to some embodiments. In some embodiments, step 712 is performed by dual-function fire suppression system 100. For example, step 712 can include puncturing a rupture disc of pressurized cylinder 110 so that the pressurized expellant gas (i.e., inert gas) within pressurizes the storage tank(s) 104 to deliver the fire suppressant agent to the hazard area 200.

Process 700 includes releasing an additional amount of expellant gas to flood the hazard area with expellant gas after the fire suppressant is exhausted. When the inert gas floods the hazard area, the inert gas helps to suppress any fire or fire conditions that are present. In some embodiments, flooding the hazard area with the inert gas when a fire condition is present facilitates preventing a fire from occurring. In this way, the dual-function fire suppression system 100 can pre-emptively respond to fire conditions to prevent a fire from occurring at hazard area. In operation, the expellant inert gas is released and pressurizes the storage tank(s) to deliver the fire suppressant stored within. At some point, the storage tank(s) are exhausted such that no material amount of fire suppressant remains to be delivered, and the nozzles transition from primarily delivering the fire suppressant to primarily delivering the expellant gas to the hazard area. As described above, the pressurized cylinder(s) containing the expellant gas are oversized such that upon exhaustion of the fire suppressant, a sufficient volume of expellant gas remains to flood the hazard area.

In some embodiments, the output of the nozzles is substantially pressurized gas. For example, after the storage tanks are effectively exhausted, the primary component of the output of the nozzles is pressurized gas. The pressurized gas may make up between 50-100% by volume/weight (i.e., volume or weight) of the output of the nozzle. In some embodiments, the pressurized gas makes up between 75-100% by volume/weight of the output of the nozzle. In some embodiments, the pressurized gas makes up between greater than 90% by volume/weight of the output of the nozzle. In some embodiments, the pressurized gas makes up greater than 99% by volume/weight of the output of the nozzle.

Referring generally to FIGS. 1-6, the dual-function fire suppression system 100 may provide certain advantages over other fire suppression systems for mobile equipment. Other fire suppression systems may not use the expellant gas to both expel a fire suppressant and flood the hazard area. Advantageously, using the expellant gas provides improved fire suppression than just using a fire suppressant agent on its own. Other inert gas fire suppression systems for mobile equipment may require dedicated gas components that increase cost and may be designed specifically for applications where liquid fire suppressants are unwanted.

### Configuration of Exemplary Embodiments

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, and/or illustrations of possible embodiments (and such terms are not intended to connote that such embodiments are necessarily extraordinary or superlative examples).

The term “coupled,” as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. Such members may be coupled mechanically, electrically, and/or fluidly.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the fire suppression system as shown in the various exemplary embodiments is illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. Other substitutions, modifications, changes, and omissions may be made in the design, operating conditions and arrangement of the exemplary embodiments without departing from the scope of the present disclosure.

The present disclosure contemplates that even in a single-agent liquid fire suppression system as described herein, in addition to the liquid fire suppressant agent a fire may also be suppressed in some part due to the expellant gas used to expel the liquid fire suppression agent from the storage tanks. It should be understood therefore that the term “single-agent” as used herein refers to a single non-gaseous phase agent system, but is not intended to exclude the additional use of gases which may also be used to address a fire. For example, when expelling the liquid fire suppressant agent using nitrogen gas, the nitrogen gas may displace a portion of the oxygen in the protected hazard area which may in turn contribute to the suppression of the fire. Such effects are understood to be included within a single-agent fire suppression system.

What is claimed is:

1. A fire suppression system for a hazard area in a vehicle, the fire suppression system comprising:
a first tank configured to contain a volume of fire suppressant;
a second tank selectively fluidly coupled to the first tank and configured to contain a volume of pressurized gas;
a nozzle having an outlet fluidly coupled to the first tank and configured to release a spray of at least one of the fire suppressant or the pressurized gas therefrom in the hazard area; and
an activator configured to selectively release the pressurized gas from the second tank such that at least a portion of the pressurized gas pressurizes the first tank, wherein at least a portion of the fire suppressant passes through the outlet of the nozzle in response to the pressurization of the first tank,
wherein after the first tank is substantially emptied at least a portion of the pressurized gas passes through the outlet of the nozzle and floods the hazard area.

2. The fire suppression system of claim 1, wherein the hazard is a substantially enclosed space of the vehicle.

3. The fire suppression system of claim 1, wherein the volume of pressurized gas is based on a volume of the hazard area.

4. The fire suppression system of claim 1, wherein the pressurized gas is an inert gas.

5. The fire suppression system of claim 1, wherein the pressurized gas is nitrogen.

6. The fire suppression system of claim 1, wherein the pressurized gas displaces at least a portion of a volume of atmosphere in the hazard area.

7. The fire suppression system of claim 1, wherein the fire suppressant is a liquid fire suppressant.

8. The fire suppression system of claim 7, wherein an ambient air temperature when the activator releases the pressurized gas is below 32° F.

9. The fire suppression system of claim 1, wherein the fire suppressant is a dry chemical fire suppressant.

10. The fire suppression system of claim 9, wherein the pressurized gas pressurizes the first tank and fluidizes the dry chemical fire suppressant, such that at least a portion of the dry chemical fire suppressant passes through the outlet of the nozzle.

11. The fire suppression system of claim 1, wherein the volume of pressurized gas comprises a first volume of pressurized gas and a second volume of pressurized gas.

12. The fire suppression system of claim 11, where in the first volume of pressurized gas is configured to deliver the fire suppressant through the nozzles.

13. The fire suppression system of claim 11, wherein the first volume of pressurized gas is based on the volume of liquid fire suppressant.

14. The fire suppression system of claim 11, wherein the second volume of pressurized gas is configured to flood the hazard area.

15. The fire suppression system of claim 11, wherein the second volume of pressurized gas is based on a volume of the hazard area.

16. The fire suppression system of claim 1, wherein after the first tank is substantially emptied an output from the outlet of the nozzle is 75-100% by volume pressurized gas.

17. The fire suppression system of claim 1, wherein after the first tank is substantially emptied an output from the outlet of the nozzle is 90-100% by volume pressurized gas.

18. The fire suppression system of claim 1, wherein after the first tank is substantially emptied an output from the outlet of the nozzle is at least 90% by volume of pressurized gas.

19. A method for suppressing a fire in a hazard area of a vehicle, the method comprising the steps of:
releasing, from a nozzle, a spray of fire suppressant in the hazard area from a first tank pressurized with a first part of a volume of pressurized gas;
releasing, from the nozzle after the first tank is substantially empty, a second part of the volume of pressurized gas into the hazard area, wherein the second part of the volume of pressurized gas floods the hazard area.

20. The fire suppression system of claim 19, wherein after the first tank is substantially emptied an output from the outlet of the nozzle is 75-100% by volume pressurized gas.
